(19) United States
(12) Patent Application Publication
(10) Pub. No.: US 2025/0078609 A1
(43) Pub. Date: Mar. 6, 2025

(54) METHODS AND SYSTEMS FOR ENHANCED OUTCOME DETERMINATIONS

(71) Applicant: PariMAX Holdings LLC, Hunt Valley, MD (US)

(72) Inventors: Paul Williams, Hollywood, FL (US); Kyle Sadlik, Reistertown, MD (US)

(21) Appl. No.: 18/614,305

(22) Filed: Mar. 22, 2024

Related U.S. Application Data
(60) Provisional application No. 63/535,020, filed on Aug. 28, 2023.

(51) Int. Cl. G07F 17/32; G06Q 50/34

(52) U.S. Cl. CPC G07F 17/3225; G06Q 50/34; G07F 17/3288

(57) ABSTRACT

Methods and systems of operating a gaming system includes using open markets from one or more competitions to determine outcomes for an electronic game machine.

### CROSS REFERENCE TO RELATED APPLICATION

This application is a Nonprovisional of U.S. Provisional Application No. 63/535,020, filed Aug. 28, 2023, the contents of which are hereby incorporated by reference.

### FIELD OF THE DISCLOSURE

Implementations of the disclosure relate to enhancements in entertainment systems, providing enhanced functionality and technical improvements over existing computing systems.

### BACKGROUND

Electronic gambling games, such as slot machine games and video poker terminals, are popular form of entertainment for players. Traditionally, such electronic gambling games are driven by random number generators to determine outcomes for these games. However, in many jurisdictions, electronic gambling games driven by random number generators are not legally permitted. Thus, electronic gambling games such as slot machine games are not legally permitted in these jurisdictions, which excludes a popular form of entertainment from many jurisdictions.

In some of these jurisdictions that restrict electronic gambling games that are driven by random number generators, other types of wagering games like sports wagering are allowed. Thus, there is a need to create new and improved legally permitted wagering games, which provide the look and feel of electronic gambling games, to satisfy players' desires engage in a popular form of entertainment that would otherwise be restricted from certain jurisdictions.

### BRIEF SUMMARY

In some aspects, the techniques described herein relate to a method of operating a gaming server, including: receiving, at a math model market selection system, a game identifier and an initial represented wager amount from an electronic game machine; determining, using the math model market selection system, a math model that corresponds to the game identifier; determining, using the math model market selection system, a math model definition associated with the math model; requesting, from a resolvable market selection system, open markets; receiving, from the resolvable market selection system, suitable open markets that are predicted to resolve within a threshold period of time; selecting, using the math model market selection system, a plurality of markets from the suitable open markets that match at least one parameter in the math model definition for the math model; determining, using the math model market selection system, a plurality of selections for the plurality of markets; sending, to a bet placement system, the plurality of selections for the plurality of markets; transmitting, to at least one sportsbook server, the plurality of selections for the plurality of markets; receiving, at the bet placement system, confirmation of a status of at least one of the plurality of selections from the at least one sportsbook server; receiving, at a bet results system, results of the plurality of selections from the at least one sportsbook server; and sending, to the electronic game machine, an outcome based on the results of the plurality of selections.

In some aspects, the techniques described herein relate to a method, wherein open markets are associated with at least one competition.

In some aspects, the techniques described herein relate to a method, further including determining a plurality of values of bets to place for the plurality of selections.

In some aspects, the techniques described herein relate to a method, wherein a sum of the plurality of values of the bets to place for the plurality of selections is the value of the initial represented wager.

In some aspects, the techniques described herein relate to a method, wherein at least two of the plurality of values of bets to place for the plurality of selections are different.

In some aspects, the techniques described herein relate to a method, wherein at least two of the plurality of values of bets to place for the plurality of selections are equal.

In some aspects, the techniques described herein relate to a method, wherein an aggregate value of winning of the bets for the plurality of selections results in a payout that matches another parameter in the math model definition for the math model.

In some aspects, the techniques described herein relate to a method, wherein open markets are associated with a plurality of different competitions.

In some aspects, the techniques described herein relate to a method, further including receiving, at the bet placement system, a rejection of at least one of the plurality of selections from the at least one sportsbook server.

In some aspects, the techniques described herein relate to a method, further including determining that a portion of the outcome is a bet value associated with the rejected at least one of the plurality of selections.

In some aspects, the techniques described herein relate to a method, further including: requesting, from a resolvable market selection system, additional open markets; receiving, from the resolvable market selection system, suitable additional open markets that are predicted to resolve within the threshold period of time; selecting, using the math model market selection system, at least one additional market from the suitable additional open markets that match the at least one parameter in the math model definition for the math model; determining, using the math model market selection system, an additional selection for the at least one additional market to replace the rejected at least one of the plurality of selections; sending, to a bet placement system, the additional selection for the at least one additional market; transmitting, to the at least one sportsbook server, the additional selection for the at least one additional market; receiving, at the bet placement system, confirmation of placement of the additional selection for the at least one additional market from the at least one sportsbook server; receiving, at a bet results system, results of the additional selection for the at least one additional market from the at least one sportsbook server; and adding the result of the additional selection for the at least one additional market to the outcome.

In some aspects, the techniques described herein relate to a gaming server, including: at least one processor; and at least one memory that stores computer executable instructions, wherein, when the computer executable instructions are executed by the at least one processor, the at least one processor is configured to: receive, from an electronic game machine, a game identifier and an initial represented wager amount; determine a math model that corresponds to the game identifier; determine a math model definition associated with the math model; obtain suitable open markets that are predicted to resolve within a threshold period of time; select a plurality of markets from the suitable open markets that match at least one parameter in the math model definition for the math model; determine a plurality of selections for the plurality of markets; transmit, to at least one sportsbook server, the plurality of selections for the plurality of markets; receive, from the at least one sportsbook server, confirmation of a status of at least one of the plurality of selections from the at least one sportsbook server; receive results of the plurality of selections from the at least one sportsbook server; and send, to the electronic game machine, an outcome based on the results of the plurality of selections.

In some aspects, the techniques described herein relate to a gaming server, wherein the suitable open markets are associated with at least one competition.

In some aspects, the techniques described herein relate to a gaming server, further including determining a plurality of values of bets to place for the plurality of selections.

In some aspects, the techniques described herein relate to a gaming server, wherein a sum of the plurality of values of the bets to place for the plurality of selections is the value of the initial represented wager.

In some aspects, the techniques described herein relate to a gaming server, wherein at least two of the plurality of values of bets to place for the plurality of selections are different.

In some aspects, the techniques described herein relate to a gaming server, wherein at least two of the plurality of values of bets to place for the plurality of selections are equal.

In some aspects, the techniques described herein relate to a gaming server, wherein an aggregate value of winning of the bets for the plurality of selections results in a payout that matches another parameter in the math model definition for the math model.

In some aspects, the techniques described herein relate to a gaming server, wherein suitable open markets are associated with a plurality of different competitions.

In some aspects, the techniques described herein relate to a gaming server, wherein the computer executable instructions further cause the at least one processor to: receive a rejection of at least one of the plurality of selections from the at least one sportsbook server.

In some aspects, the techniques described herein relate to a gaming server, wherein the computer executable instructions further cause the at least one processor to: determine that a portion of the outcome is a bet value associated with the rejected at least one of the plurality of selections.

In some aspects, the techniques described herein relate to a gaming server, wherein upon receiving the rejection of the at least one of the plurality of selection, the computer executable instructions further cause the at least one processor to: obtain suitable additional open markets that are predicted to resolve within the threshold period of time; select at least one additional market from the suitable additional open markets that match the at least one parameter in the math model definition for the math model; determine an additional selection for the at least one additional market to replace the rejected at least one of the plurality of selections; transmit, to the at least one sportsbook server, the additional selection for the at least one additional market; receive confirmation of placement of the additional selection for the at least one additional market from the at least one sportsbook server; receive results of the additional selection for the at least one additional market from the at least one sportsbook server; and add the result of the additional selection for the at least one additional market to the outcome.

### BRIEF DESCRIPTION OF THE FIGURES

FIG. 1 is a block diagram illustrating a microbet system, according to some implementations of the present disclosure.

FIG. 2 is a block diagram illustrating a microbet server, according to some implementations of the present disclosure.

FIG. 3A is a flowchart illustrating a method of operating a microbet gaming server, according to some implementations of the present disclosure.

FIG. 3B is a flowchart extending from FIG. 3A and further illustrating the method of operating a microbet gaming server, according to some implementations of the present disclosure.

FIG. 4 illustrates communications and processes between different devices and/or systems of a microbet system according to some implementations of the present disclosure.

FIG. 5 illustrates communications and processes between different devices and/or systems of a microbet system according to some implementations of the present disclosure.

FIG. 6A is an illustration of an example game screen using the microbet system according to some implementations of the present disclosure.

FIG. 6B is an illustration of a table showing an example of a player's wager in a microbet system that is split between various selections (e.g., bets), odds for the selections, and bet amount, and value of the selection if won, according to some implementations of the present disclosure.

FIG. 6C is an illustration of an example game screen using the microbet system according to some implementations of the present disclosure.

FIG. 6D is an illustration of an example game screen using the microbet system according to some implementations of the present disclosure.

FIG. 6E is an illustration of an example game screen using the microbet system according to some implementations of the present disclosure.

### DETAILED DESCRIPTION

The systems and methods described herein provide a new form of gaming that provides the look and feel of a first type of game (e.g., traditional casino games or other suitable games), but use legally permitted aspects of sports wagering to determine game outcomes with microbets, which gives players new forms of entertainment that were not previously available.

Prior to the present disclosure, combining sports wagering and traditional casino games was not feasible. Traditional casino games need outcomes that are decided quickly, such as provided by random number generators. For example, a player playing a reel-based slot machine game may need one or more outcomes provided in a matter of seconds. Traditionally, sports wagering revolved around simple bets, such as bets on the final outcomes of competitions (e.g., wagering on whether a particular football team or baseball team would win a game). Outcomes of most sport competitions can take hours to resolve. Thus, traditional sports wagering was not compatible with traditional casino games because outcomes in sports wagering can take too long to resolve.

More recently, in some online sportsbooks, players can wager or bet on a variety of sports (e.g., competitions) with many more betting opportunities (e.g., markets) that occur within a competition. These sporting competitions may occur worldwide and at different leagues and levels. Because these sporting events may be occurring worldwide, these sporting events also may occur at various different times of the day (e.g., sports played in Australia may be played during the evening or early morning in the USA while sports played in the USA may be played during the evening or early morning in the Australia). This provides round the clock competitions and larger markets for more betting opportunities.

In addition to wagering on final outcomes of a game, or how a particular team is performing at major or minor milestones (e.g., at a quarter mark of a game, at half time, after the kickoff, etc.), “proposition wagers” or “prop wagers” may be placed. These “prop” wagers can be focused on an event or micro event that may occur during a competition.

Wagers on events or micro events in a competition give rise to many new wagers (e.g., markets) that can be resolved in a shorter period of time than from traditional sports wagers. For instance, in a tennis match, predicting the next player to make a point, predicting whether the next serve will be an ace, predicting whether the next serve will result in a fault, etc. can be created as markets for bets. In a football game, the first player or team to score a touchdown, a player surpassing a certain yardage amount, whether the next play is a run or a pass, can all be created as markets. In baseball, a bet or wager may be placed based on a sub or micro event of whether the next pitch is a ball or a strike. In horse racing, a wager may be put on a micro event of a particular horse in first (or any other position) at a certain interval in the race (e.g., ⅛ mile interval; ¼ mile interval etc.). In a motor sports example, a micro event such as who is in the lead at a particular lap number or mile marker can become a wager. There also exists other variations for micro events for car racing, such as a particular car's speed mark, number of car lengths a chosen car is ahead or behind another chosen car.

These newer types of sports wagers provide an opportunity to create new sports wagering games, whose outcomes can be obtained rapidly enough to supply outcomes to fast paced casino type games. However, to use sports wagers, a system would need to overcome numerous technological obstacles. The system would need to be able to gather enough potential markets to satisfy the outcome needs of players at electronic game machines, the outcomes for the markets would need to be determined quickly enough that players would not perceive a lag in starting a game and getting an outcome in the game, and outcomes selected for the selected markets would need to provide appropriate potential payouts to conform to a return to player (“RTP”) percentage needed for a particular game. Obtaining vast volumes of real-time market (bet) data, sorting and selecting such market data, keeping such market data update to date and accurate, and obtaining outcomes for the market data such that the outcomes can be used for another game creates a computational challenge. As will be discussed herein, various implementations of systems and methods solve these challenging technical problems to enable providing the look and feel of a first type of game (e.g., traditional casino games or other suitable games), but use legally permitted aspects of sports wagering to determine game outcomes with microbets. While sport wagering traditionally uses fixed odds wagering, in some implementations, the micro bets on sport wager markets can be configured to use parimutuel wagering as an alternative to fixed odds wagering.

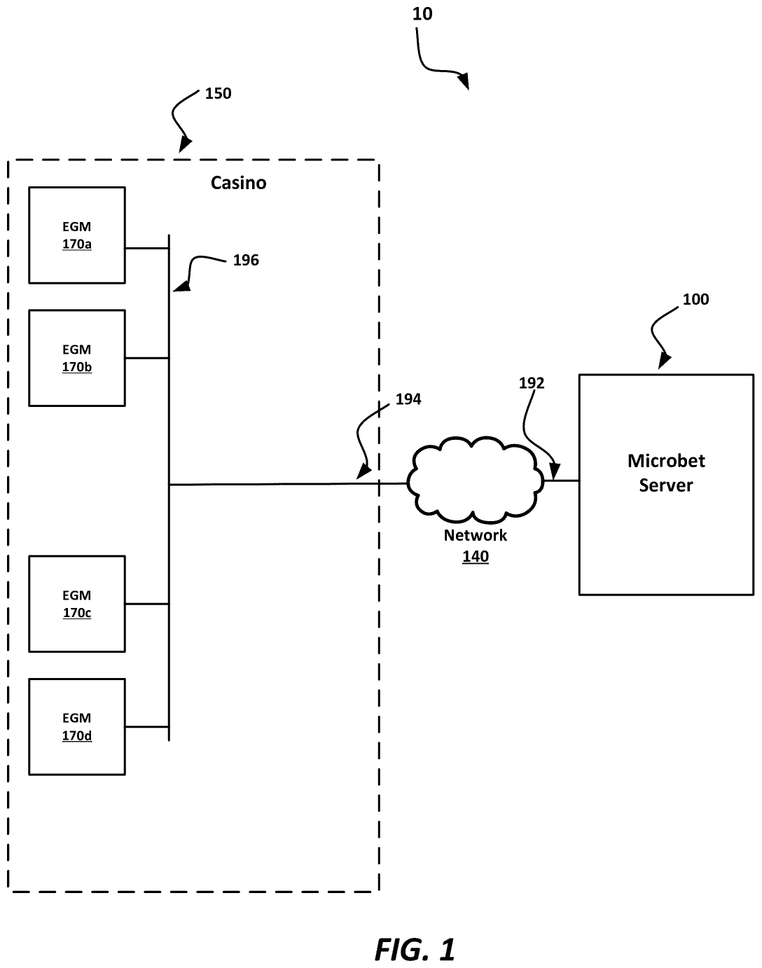

FIG. 1 is a block diagram that describes a system 10, according to some implementations of the present disclosure. In some implementations, system 10 may include one or more servers like microbet server 100. In some implementations, system 10 may include one or more portions of the system in a casino 150. It should be appreciated that casino 150 can be any suitable location, such as gaming floor at horse track, a gaming floor at a sports wagering facility, a gas station, a player's home, etc. For example, in some implementations, the system 10 may include a plurality of electronic game machines, such as electronic game machine 170a, electronic game machine 170b, electronic game machine 170c, and electronic game machine 170d. In some implementations, electronic game machines may communicate with the microbet server 100 via a network such as network 140. In some implementations, microbet server 100 may be located in a casino, such as casino 150 and communicate with electronic game machines via a local area network. In some implementations, these systems work together to provide a novel microbet system that can incorporate aspects of one type of game (e.g., such as a slot machine), with sports wagering.

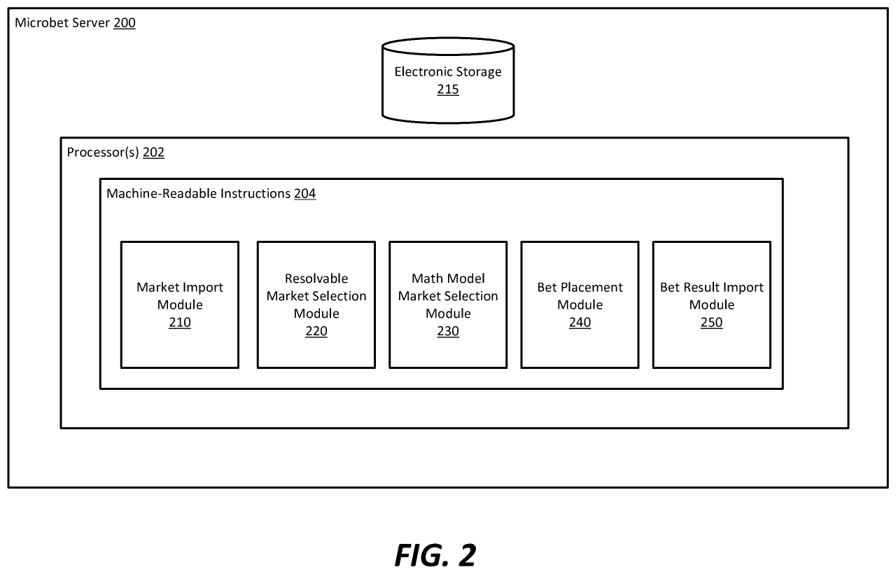

In some implementations, some portions of system 10 can be provided by microbet server 100. In some implementations, the microbet server 100 is configured to convert a player's initial represented wager on a first game into sports wagering bets and outcomes for the system 10 that are used as part of the first games. The initial represented wager is an amount that the player decides to risk or stake to play the first game. However, in some implementations, until the initial represented wager is converted into a plurality of bets or micro bets on markets in competitions, the initial amount may not yet be a true bet as a player would make to play a traditional slot machine game. In some implementations, microbet server 100 can be one or more servers in a data center or a cloud-based computing system. In some implementations, microbet server 100 is a server, such as described in connection with FIG. 2. In some implementations where microbet server 100 includes more than one server, the different servers may provide the same or similar functions. In some implementations where microbet server 100 includes more than one server, the different servers may provide different functions. Some of these different functions that can be separated into different servers are described in connection with FIG. 2. In some implementations, the microbet server 100 may comprise stand-alone computing devices. In some implementations, microbet server 100 may include, but is not limited to, interface devices such as computer monitors, touch screens, buttons, etc. In some implementations, microbet server 100 may include one or more processors, one or more types of non-transitory memory devices (e.g., RAM, ROM, etc.), network interface devices, etc. By way of non-limiting example, microbet server 100 may include one or more of a server, a desktop computer, a laptop computer, a handheld computer, and/or other suitable computing platforms. The structure and functions of some implementations of the microbet server 100 will be described in greater detail herein.

In some implementations, microbet server 100 can be in communication with other devices or systems. For example, in some implementations, microbet server 100 can be in communication with other devices or systems through a suitable network, such as network 192. In some implementations, network 192 is at least one local area network (LAN). In some implementations, network 192 is a plurality of LANs. In some implementations, network 192 is at least one wide area network (WAN). In some implementations, network 192 is a plurality of WANs. In some implementations, network 192 is a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™, Bluetooth™, satellite, etc.). In some implementations, network 192 may be connected to a network 140. In some implementations, network 140 is one or more public networks (e.g., the Internet). In some implementations, network 140 is one or more private networks. In some implementations, network 140 is a combination of one or more public networks and one or more private networks.

In some implementations, microbet server 100 may communicate with one or more devices in a casino 150 or other suitable locations that provide access to sports wagering based games to players. In some implementations, devices that are part of the microbet system 10 in casino 150 may include one or more electronic game machines (also referred to herein as EGMs) such as, electronic game machine 170a, electronic game machine 170b, electronic game machine 170c, and electronic game machine 170d. In some implementations, system 10 in casino 150 may include one or more proxy servers. In some implementations, system 10 may include one or more casinos with one or more of the devices described herein.

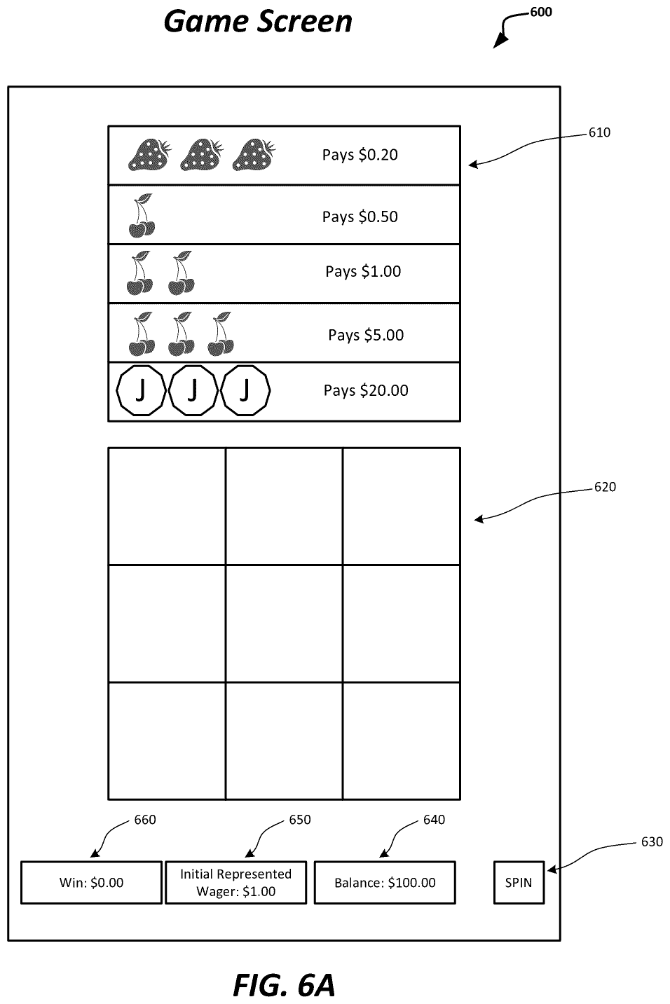

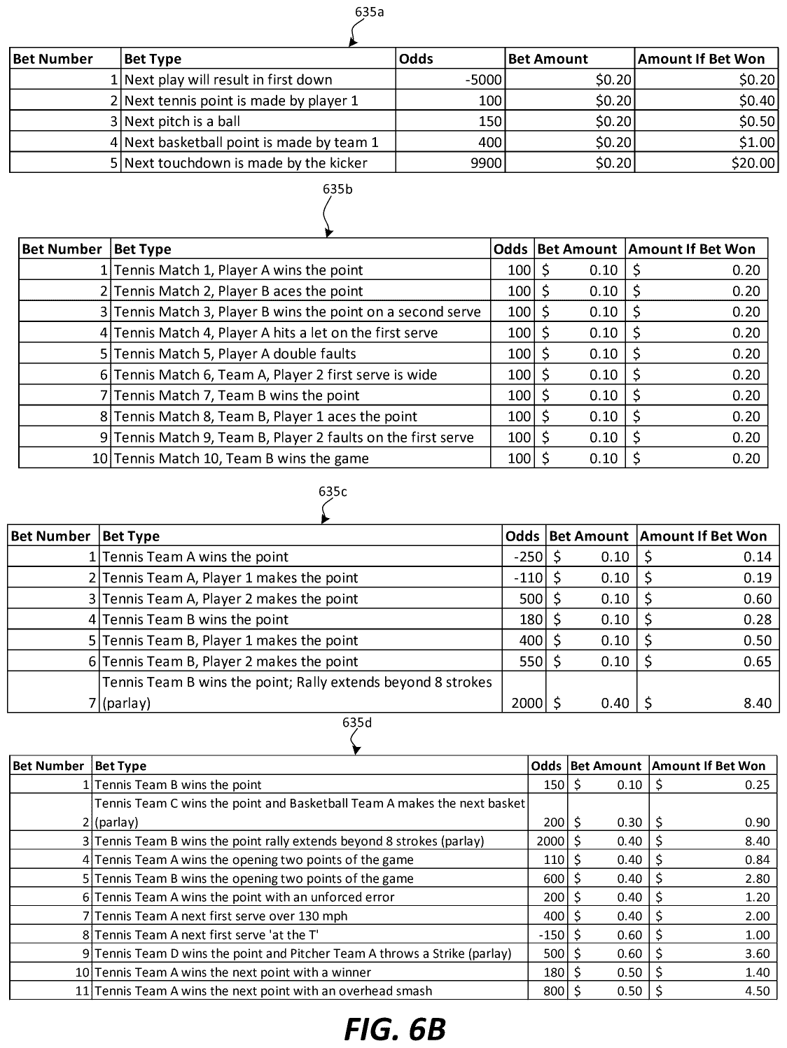

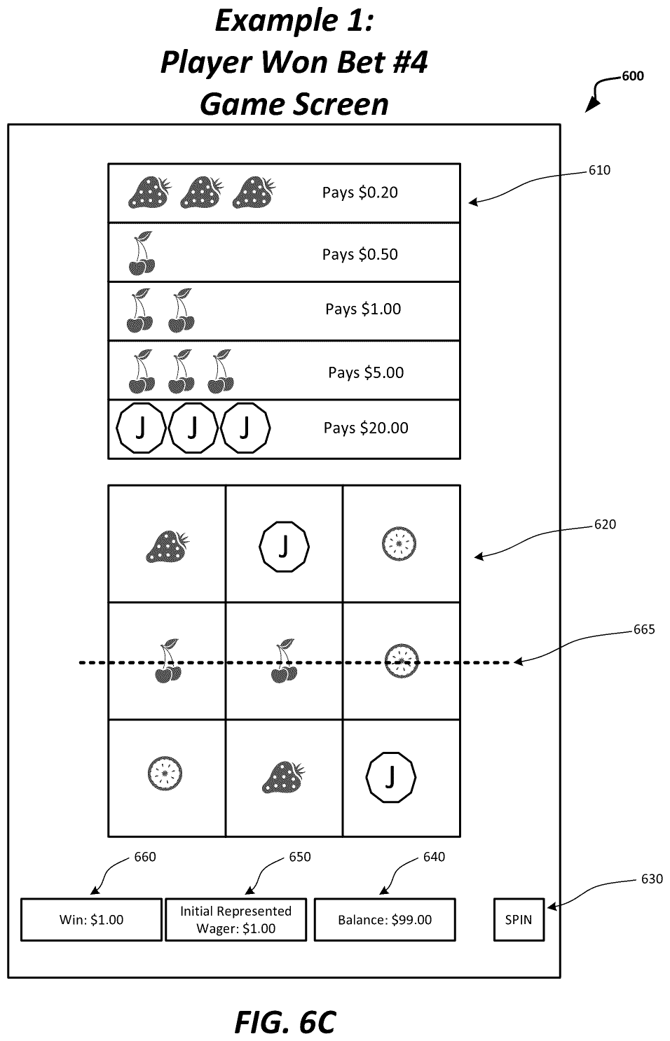

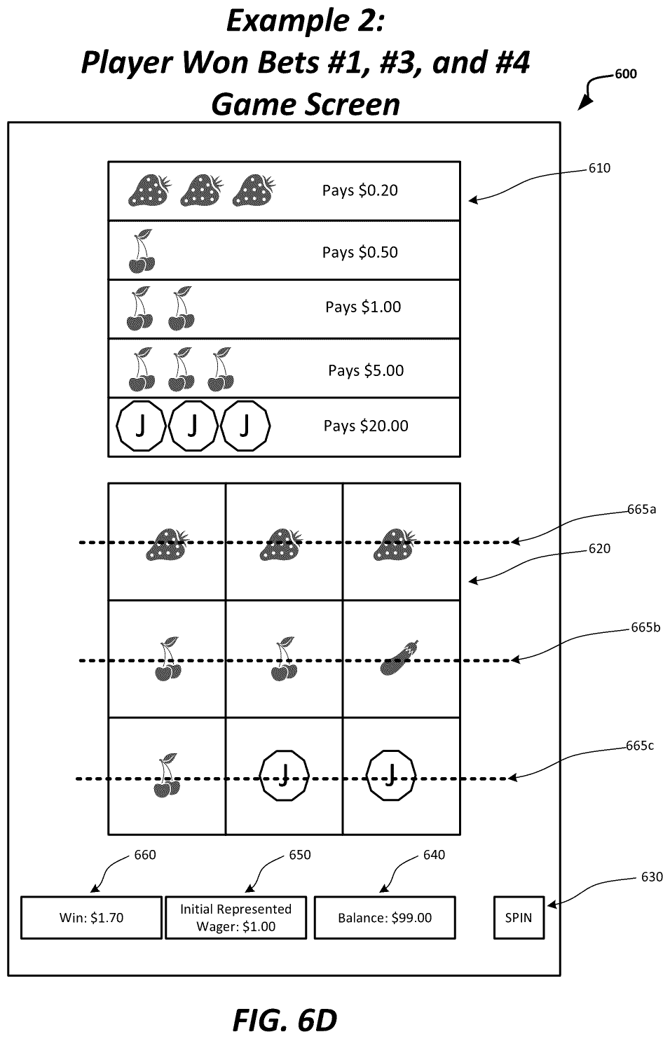

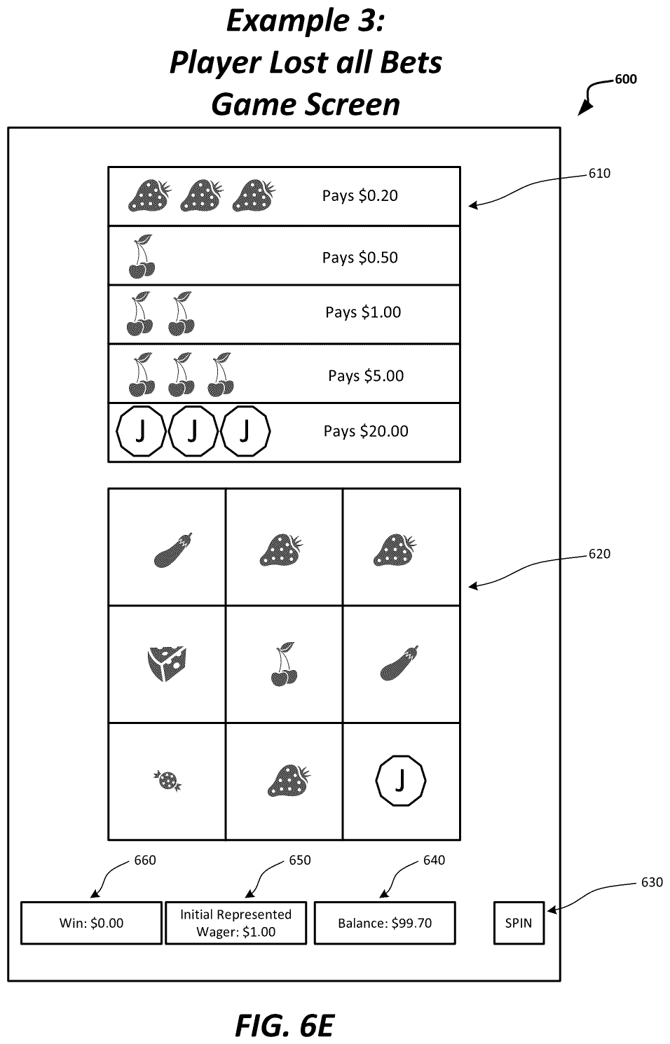

In some implementations, casino 150 may include one or more electronic game machines (EGMs). It should be appreciated that casino 150 may include any suitable number of EGMs. In some implementations, an EGM may include a game interface, which provides a way to interact with the EGMs. In some implementations, the game interface provides an entertaining display to a player, enables a player to make or cancel bets/wagers, view their balance, etc. In some implementations, the game interface may include aspects of a first game such as a slot machine game or other suitable game interface. One example of a game interface that can be displayed by an EGM is illustrated in FIG. 6A-FIG. 6D. In some implementations, an EGM may include one or more functions to communicate with the microbet server 100. In some implementations, communications from an EGM to the microbet server 100 can be encrypted.

In some implementations, EGMs are user interface devices that may comprise stand-alone computing devices. In some implementations, EGMs can be client terminals in a client/server system. EGMs can be used to accept player inputs for a game, such as game selections, wagers, player tracking cards, etc. EGMs may include, but are not limited to, player interface devices such as computer monitors, touch screens, buttons, card and ticket readers, ticket printers, etc. In some implementations, EGMs may include or be in communication with one or more cashless wallet systems for accepting player funds that can be converted credits or chips for wagers. EGMs may include one or more processors, one or more types of non-transitory memory devices (e.g., RAM, ROM, etc.), network interface devices, etc. By way of non-limiting example, given EGMs may include one or more of a server, a desktop computer, a laptop computer, a handheld computer, a tablet computing platform, a smartphone, a gaming console, and/or other computing platforms. In some implementations, EGMs can be used to play one or more different games. It should be appreciated that in implementations where an EGM is a mobile device (e.g., a laptop computer, a handheld computer, a tablet computing platform, a smartphone, etc.) and where regulations permit, such a mobile EGM may permit a player to play one or more different games outside of a casino environment. In some implementations, a mobile EGM may permit a player to play one or more different games anywhere regulations permit game play.

In some implementations, the devices in casino 150 can be in communication with each other. For example, in some implementations, electronic game machine 170a, electronic game machine 170b, electronic game machine 170c, and electronic game machine 170d, can be in communication with each other through a suitable network, such as network 196. In some implementations, network 196 is at least one LAN. In some implementations, network 196 is a plurality of LANs. In some implementations, network 196 is at least one WAN. In some implementations, network 196 is a plurality of WANs. In some implementations, network 196 is a combination of one or more LAN networks and one or more WAN networks. In some implementations, the LAN and/or WAN networks are hardwired networks (e.g., Ethernet™, fiber optic, etc.). In some implementations, one or more LAN and/or WAN networks can be a suitable wireless network (e.g., cellular, WiFi™, Bluetooth™, satellite, etc.). In some implementations, network 196 may be connected to a network 140 via a network link 194. In some implementations, network link 194 can be a similar network to that which was described in connection with network 192.

In some implementations, the EGMs communicate with the microbet server 100 through a proxy server (not shown). In some implementations, casino 150 may include one or more proxy servers. In some implementations, proxy server can be configured to be a central hub for communication to and from EGMs. In some implementations, proxy server can translate messages from the EGMs and send them to the microbet server 100. In some implementations, a proxy server can also be configured to act as a dynamic host control protocol (DHCP) server for the EGMs to establish the Internet Protocol (IP) addresses for the EGMs. In some implementations, the proxy server may comprise a computer and/or a server. In some implementations, the proxy server may comprise stand-alone computing devices. In some implementations, proxy server may include, but is not limited to, interface devices such as computer monitors, touch screens, buttons, etc. In some implementations, proxy server may include one or more processors, one or more types of non-transitory memory devices (e.g., RAM, ROM, etc.), network interface devices, etc. By way of non-limiting example, the proxy server may comprise one or more of a server, a desktop computer, a laptop computer, a handheld computer, and/or other suitable computing platforms.

FIG. 2 is a block diagram illustrating a microbet server 200, according to some implementations of a microbet system. In some implementations, microbet server 200 in FIG. 2 is one possible representation of a microbet server previously described, such as microbet server 100 previously discussed. In some implementations, microbet server 200 may include one or more computing platforms. Microbet server 200 may be configured to communicate with one or more devices according to a client/server architecture, a peer-to-peer architecture, and/or other suitable architectures. Users may interact with the microbet server 200 via certain devices as discussed herein. In some implementations, the microbet server 200 may include one or more processers 202, one or more electronic storage devices 215 (e.g., non-transitory memory devices), and machine-readable instructions 204. In some implementations, electronic storage 215 may include one or more databases.

Microbet server 200 may be configured by machine-readable instructions 204. Machine-readable instructions 204 may include one or more instruction modules. The instruction modules may include computer program modules. The instruction modules may include one or more of, but are not limited to, a market import module 210, a resolvable market selection module 220, a math model market selection module 230, a bet placement module 240, and a bet result import module 250, and/or other instruction modules.

In some implementations, the market import module 210 is configured to execute and run on the microbet server 200 to obtain available competitions such as, but not limited to American Football, Aussie Rules Football, Baseball, Basketball, Boxing, Cornhole, Cricket, Cycling, Darts, E-Sports, American Football, F1, Golf, Handball, Ice Hockey, Horse Racing, Lacrosse, MMA (Mixed Martial Arts), Motor Sports, Rugby, Snooker, Soccer, Table Tennis, Tennis, Volleyball and any other sport or racing competition from one or more sportsbook servers. In some implementations, the market import module 210 also obtains open markets that are associated with the available competitions. In some implementations, open markets are available bets from one or more sportsbook servers. For example, an available competition at a sportsbook server can be an in-play singles tennis match, wherein open markets may include bets on the outcome of the next serve, outcome of the next game, etc. As another example, if an available competition at a sportsbook server is a horse race that hasn't finished, open markets may include typical bets that can be made on the horse race (e.g., win, place, show, etc.). In some implementations, market import module 210 may request that one or more sportsbook servers provide available competitions and open markets associated with the available competitions. In some implementations, to obtain the available competitions and associated open markets, the market import module 210 may establish a connection to one or more sportsbook servers to receive the competition and open market information. In some implementations, the market import module 210 may communicate with the sportsbook servers via application programming interfaces (“APIs”) or using other suitable communications mechanisms. In some implementations, market import module 210 may request the competition and open market information from the one or more sportsbook servers. In some implementations, the one or more sportsbook servers may push or broadcast the information to market import module 210. In some implementations, the market import module 210 may pull the information from the one or more sportsbook servers. In some implementations, the competition and associated open market information can be obtained by market import module 210 using a combination of requests, pulls, broadcast, and/or pushes from the one or more sportsbooks server. In some implementations, the market import module 210 may store information associated with available competitions and open markets in one or more data storage locations such as electronic storage 215. As a competition ends or as a market resolves/closes/completes market import module 210 may remove competitions that ended and/or markets that closed from the one or more data storage locations. In some implementations, market import module 210 may deliver available competitions and open markets to the resolvable market selection module 220 by request or market import module 210 may push such information to the resolvable market selection module 220 when new markets open or previously open markets close. In some implementations, microbet server 200 may include one or more running instances of a market import module 210.

In some implementations, a resolvable market selection module 220 is configured to execute and run on the microbet server 200. In some implementations, the resolvable market selection module 220 is configured to perform functions such as determining open markets that are likely to close or resolve within one or more periods of time. This enables the microbet server 200 to accurately place selections (e.g., bets) on markets that are open at a sportsbook server and avoid attempting to place selections on markets that have closed/resolved or competitions that have ended. In some implementations, resolvable market selection module 220 may obtain open markets from the market import module 210. In some implementations, resolvable market selection module 220 may evaluate open markets received form market import module 210 to determine which of such open markets are most likely to resolve within one or more periods of time (e.g., open markets that will end in 10 seconds, open markets that will end in 15 seconds, open markets that will end within 30 seconds, open markets that will end within 1 minute, etc.). In some implementations, resolvable market selection module 220 may analyze open markets based on their associated estimated times the open markets will close or resolve to sort and organize such open markets for rapid sharing with other modules, such as math model market selection module 230. In some implementations, resolvable market selection module 220 may retain one or more resolvable markets in one or more data storage locations such as electronic storage 215. In some implementations, microbet server 200 may include one or more running instances of a resolvable market selection module 220.

In some implementations, a math model market selection module 230 is configured to execute and run on the microbet server 200. In some implementations, the math model market selection module 230 is configured to select open markets that are likely to close within a predetermined time period and that can also be used to satisfy one or more of the requirements of a math model definition for a particular game. In some implementations, the selection of markets is based on the time in which the markets will resolve as the initial filter, then math model market selection module 230 may further filter markets to select based on another math model definition attribute, such as odds and/or bet amount to determine whether the selection (when combined with one or more other selections) will conform to an RTP percentage set in the math model definition. In some implementations, the math model market selection module 230 may be provided with timing information (e.g., obtained from a sportsbook server providing an open market, such as a serve clock in a tennis match, a play clock in American Football or a shot clock in basketball (or some other suitable countdown or timer) that indicates when an open market should end. In some implementations, the math model market selection module 230 may be configured with estimates of how long particular open markets will stay open based on average lengths of time typically allotted for such open markets to close (e.g., the next serve in a tennis match will complete in less than 15 seconds, the Preakness® race will complete within about 2 minutes or less, the next pitch in a baseball game will complete within 15 or 20 seconds, etc.). Thus, in some implementations where a sportsbook server does not supply how long an open market will stay open, the math model market selection module 230 can assign a time that a particular open market will stay open for a selection (e.g., a bet) based on predetermined data such as estimates from preexisting data. In some implementations, the resolvable market selection system 220 will perform the analysis regarding how long markets will stay open. In some implementations, the math model market selection module 230 may receive, among other information, bet requests from one or more electronic game machines. In some implementations, the bet requests may include information such as, but not limited to, a game identifier, game denomination, and initial represented wager amount. For example, if a player is at an electronic game machine playing a game called Hammer Down, the math model market selection module 230 may receive a bet request from the electronic game machine where the game identifier could be Hammer Down or HD, the denomination could be $0.01, and the initial represented wager amount could be $0.60. In some implementations, the math model market selection module 230 may obtain a game theme definition from a game configuration database based on the game identifier, where the game theme definition may identify the appropriate math model. In some implementations, the math model market selection module 230 may obtain a math model definition from a math model database. In some implementations, the math model market selection module 230 may send requests for market selections (e.g., bet selections to place on open markets) to a bet placement module 240. In some implementations, math model market selection module 230 may also obtain updates of open markets from the resolvable market selection module 220 for market selections that failed to be placed with a sportsbook server and make additional selections (e.g., bets) for other open markets. In some implementations, where a selection was not accepted by a sportsbook server, the math model market selection module 230 may determine that the selection could not be placed and the selection (and associated bet value) will be sent to a bet result import module 250. As will be discussed further herein, in some implementations, a bet value associated with a failed selection can be converted to part of the player's win amount by a bet result import module 250. In some implementations, microbet server 200 may include one or more running instances of a math model market selection module 230.

In some implementations, a bet placement module 240 is configured to execute and run on the microbet server 200. In some implementations, the bet placement module 240 sends selections (e.g., bets) associated with open markets to one or more sportsbook servers. In some implementations, the bet placement module 240 may include functions to receive selections (e.g., bet type, bet amount, etc.) from the math model market selection module 230. In some implementations, the bet placement module 240 may send the selections to one or more sportsbook servers so that bets can be placed. For example, in some implementations, the bet placement module 240 may send selections destined to one sportsbook server in one or more messages. In some implementations, the bet placement module 240 may send selections destined to different sportsbook servers in one or more different messages. In some implementations, a sportsbook server may reject one or more selections. In some implementations, the bet placement module 240 may be configured such that selections that can be placed at the sportsbook server are placed while the bet placement module 240 notifies math model market selection module 230 of the one or more selections that were rejected by a sportsbook server. In some implementations, the bet placement module 240 may be configured such that selections are placed using an all or nothing basis. That is, in some implementations, bet placement module 240 may prevent one or more selections from being placed with a sportsbook server when all selections sent to a sportsbook server could not be placed. In some implementations, bet placement module 240 may separately send a sportsbook server individual selections. In some implementations, bet placement module 240 may send placement statuses of the selections to the math model market selection module 230 based on communications from one or more sportsbook servers. In some implementations, microbet server 200 may include one or more running instances of a bet placement module 240.

In some implementations, a bet result import module 250 is configured to execute and run on the microbet server 200. In some implementations, bet result import module 250 communicates with one or more sportsbook servers and obtains results of selections sent to the one or more sportsbook servers by bet placement module 240. In some implementations, bet result import module 250 can be configured to deliver outcome results of the selections to one or more electronic game machines. In some implementations, bet result import module 250 may establish a connection to one or more sportsbook servers to receive the results of selections by requesting the information from a sportsbook server or receiving a push, requesting a pull, or broadcast notification from a sportsbook server. In some implementations, bet result import module 250 may deliver selection information such as, but not limited to, market information, market selections made, bet value, and payout information to one or more electronic game machines. In some implementations, microbet server 200 may include one or more running instances of a bet result import module 250.

While certain features and functions of the market import module 210, resolvable market selection module 220, math model market selection module 230, bet placement module 240, and/or bet result import module 250 were described, it should be appreciated that the features and functions of these modules are not limited to descriptions provided herein. Furthermore, additional features and functions of the microbet server 200 and its modules are described in greater detail herein.

In some implementations, microbet server 200 may be operatively linked to other devices via one or more electronic communication links (e.g., network 140, network 192, and/or network 196, etc.). For example, such electronic communication links may be established, at least in part, via a network such as the Internet and/or other networks. It will be appreciated that this is not intended to be limiting, and that the scope of this disclosure includes implementations in which microbet server 200 may be operatively linked to other devices via some other communication systems. In some implementations, microbet server 200 may be operatively linked to other microbet servers via suitable communication systems. By way of non-limiting example, a given microbet server 200 may include one or more of a server and/or other suitable computing platforms.

Microbet server 200 may include electronic storage 215, one or more processors 202, and/or other components. Microbet server 200 may include communication lines, or ports to enable the exchange of information with a network and/or other computing platforms. The illustration of microbet server 200 in FIG. 2 is not intended to be limiting. Microbet server 200 may include a plurality of hardware, software, and/or firmware components operating together to provide the functionality attributed herein to microbet server 200. For example, microbet server 200 may be implemented by a cloud of computing servers and/or platforms operating together as microbet server 200.

Electronic storage 215 may comprise non-volatile or non-transitory storage media that electronically stores information. The electronic storage media of electronic storage 215 may include one or both of system storage that is provided integrally (i.e., substantially non-removable) with microbet server 200 and/or removable storage that is removably connectable to microbet server 200 via, for example, a port (e.g., a USB port, a firewire port, etc.) or a drive (e.g., a disk drive, etc.). Electronic storage 215 may include one or more of optically readable storage media (e.g., optical disks, etc.), magnetically readable storage media (e.g., magnetic tape, magnetic hard drive, etc.), electrical charge-based storage media (e.g., EEPROM, RAM, etc.), solid-state storage media (e.g., flash drive, etc.), and/or other electronically readable storage media. Electronic storage 215 may include one or more virtual storage resources (e.g., cloud storage, a virtual private network, and/or other virtual storage resources). Electronic storage 215 may store software algorithms, information determined by processor(s) 202, information received from microbet server 200, information received from other devices (e.g., EGMs, proxy servers, sportsbook servers, etc.), and/or other information that enables microbet server 200 to function as described herein. In some implementations, electronic storage 215 may store a game configuration database, a math model database, as well as other suitable databases.

In some implementations, a game configuration database is configured to service requests from the resolvable market selection module 220. In some implementations, the game configuration database may be configured to store one or more game themes and associated denominations that are available for play at one or more electronic game machines. In some implementations, the game configuration database may also store a defined math model for one or more game theme/denomination combination. In some implementations, the game configuration database can store data that is specific to a particular sportsbook server. In some implementations, the game configuration database can store data for one or more sportsbook servers. In some implementations, the game configuration database may exist on the same physical server as one or more modules discussed herein (e.g., the resolvable market selection module 220). In some implementations, the game configuration database may stored on a physically separate server from one or more of the modules discussed herein.

In some implementations, a math model database is configured to execute and run on the microbet server 200. In some implementations, the math model database is configured to service requests from the resolvable market selection module 220. In some implementations, math model database stores definitions for one or more math models. In some implementations, a math model definition may include, but is not limited to, a math model identifier, a designated Return to Player (RTP) percentage for a base game and/or one or more associated bonus games, hit frequencies (e.g., volatility), applicable denominations, minimum and maximum bet amounts, a configuration of necessary odds of open markets to bet on to conform to the designated RTP percentage for the associated math model, number of markets to select, weighting of one or more bets in accordance with the designated odds, other information about associated bonus games, information regarding persistence (e.g., persistence of symbols, collection of game objects between reel spins, or other game features such as progressive prizes). In some implementations, the math model database may exist on the same physical server as one or more modules discussed herein (e.g., the resolvable market selection module 220). In some implementations, the math model database may be stored on a physically separate server from one or more of the modules discussed herein.

Processor(s) 202 may be configured to provide information processing capabilities in microbet server 200. As such, processor(s) 202 may include one or more of a digital processor, an analog processor, a digital circuit designed to process information, an analog circuit designed to process information, a state machine, and/or other mechanisms for electronically processing information. Although processor(s) 202 is shown in FIG. 2 as a single entity, this is for illustrative purposes only. In some implementations, processor(s) 202 may include a plurality of processing units. These processing units may be physically located within the same device, or processor(s) 202 may represent processing functionality of a plurality of devices operating in coordination. Processor(s) 202 may be configured to execute market import module 210, resolvable market selection module 220, math model market selection module 230, bet placement module 240, bet result import module 250 and/or other modules as well as various databases. Processor(s) 202 may be configured to execute market import module 210, resolvable market selection module 220, math model market selection module 230, bet placement module 240, bet result import module 250 and/or other modules by software; hardware; firmware; some combination of software, hardware, and/or firmware; and/or other mechanisms for configuring processing capabilities on processor(s) 202. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although market import module 210, resolvable market selection module 220, math model market selection module 230, bet placement module 240, and bet result import module 250 are illustrated in FIG. 2 as being implemented within a single processing unit, in implementations in which processor(s) 202 includes multiple processing units, one or more of market import module 210, resolvable market selection module 220, math model market selection module 230, bet placement module 240, and/or bet result import module 250 may be implemented on different processors from the other modules. In some implementations, one or more of market import module 210, resolvable market selection module 220, math model market selection module 230, bet placement module 240, and bet result import module 250 may be implemented on one or more separate servers. The description of the functionality provided by the different modules and databases (e.g., market import module 210, resolvable market selection module 220, math model market selection module 230, bet placement module 240, and/or bet result import module 250, game configuration database, math model database, etc.) described herein is for illustrative purposes, and is not intended to be limiting. Any of market import module 210, resolvable market selection module 220, math model market selection module 230, bet placement module 240, bet result import module 250, game configuration database, and/or math model database may provide more or less functionality than is described. For example, one or more of market import module 210, resolvable market selection module 220, math model market selection module 230, bet placement module 240, bet result import module 250, game configuration database, and/or math model database may be eliminated, and some or all of their functionality may be provided by other ones of such modules or eliminated. As another example, processor(s) 202 may be configured to execute one or more additional modules that may perform some or all of the functionality attributed herein to one of market import module 210, resolvable market selection module 220, math model market selection module 230, bet placement module 240, bet result import module 250, game configuration database, and/or math model database.

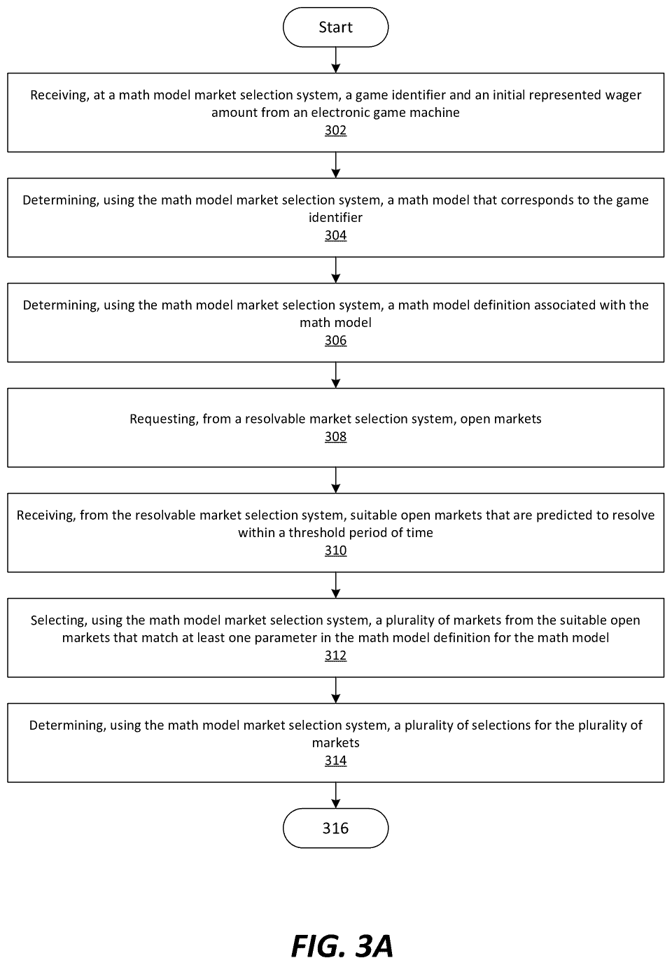

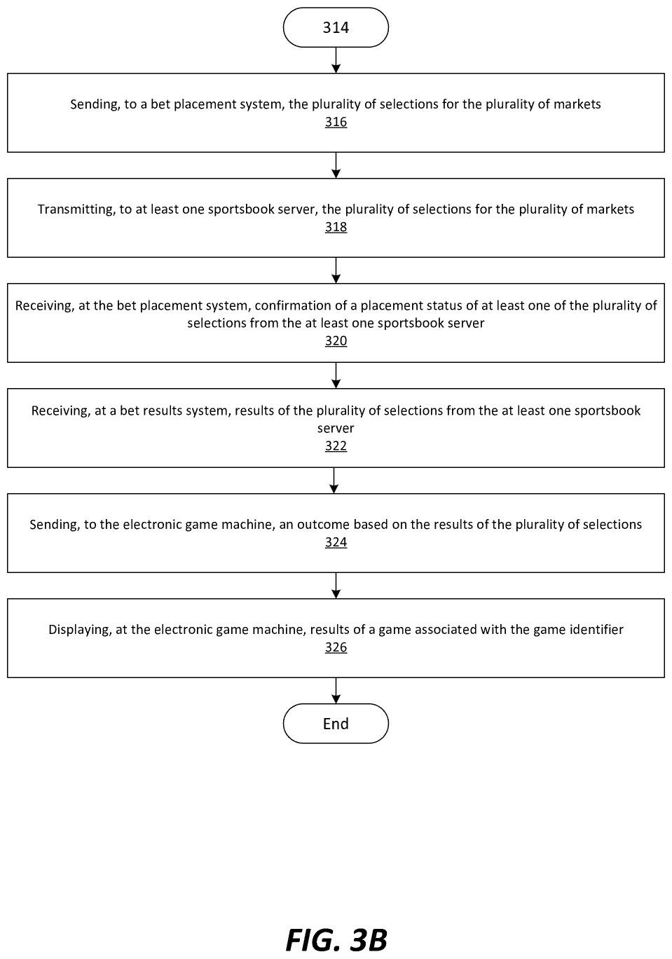

FIGS. 3A and 3B are flowcharts that describe some methods of operating a gaming server such as microbet server 100 and microbet server 200, according to some implementations of a microbet system. In some implementations, the gaming server operates within a microbet system. In some implementations the microbet system combines the interface of a first game with sports wagering. In some implementations, the interface of the first game can be, but is not limited to, slot-type games, big 6 wheel, roulette, craps, pai gow, sic bo, baccarat, blackjack, poker and its variations (e.g. texas hold 'em, double double poker, deuces wild, etc.), war, etc. In some implementations, the player can interact with the first game on an electronic game machine, such as a suitable slot machine style interface (e.g., a reel-based slot machine interface) and the electronic game machine may directly or indirectly communicate with the gaming server to provide the sports wagering aspects. As will be discussed herein, in some implementations, the player's initial represented wager on a first game at the electronic game machine can be converted into one or more sports wagers/bets (e.g., selections) placed on one or more different markets associated with one or more different competitions. In some implementations, the outcome of the first game on the electronic game machine is based on the outcome of the one or more sports wagers. It should be appreciated that the order of the process illustrated in FIG. 3A and FIG. 3B is merely one possible implementation. In some implementations, the process illustrated in FIG. 3A and FIG. 3B may include more blocks or fewer blocks (e.g., more processes or fewer processes). In some implementations, the order of the blocks in FIG. 3A and FIG. 3B can be arranged in a different order than illustrated and described herein.

In some implementations, as shown at 302, the method may include receiving, at a math model market selection system (e.g., math model market selection module 230), a game identifier and an initial represented wager amount from an electronic game machine. For example, a player may have selected an initial represented wager amount and hit spin at a slot machine interface presented at the electronic game machine. In some implementations, the initial represented wager amount may look like a typical bet at a slot machine game, but may not be a true bet until it is converted into one or more bets or microbets (e.g., when one or more bets are placed on one or more sports wager events/markets). In some implementations, the electronic game machine sends the initial represented wager amount and an identification of the slot machine game to the math model market selection system. In some implementations, as will be described in greater detail below, this may trigger the determination of a plurality of microbets (e.g., selections), and placing the microbets at a sportsbook server, and using the outcome/winnings of the microbets to determine the outcome of the game at the electronic game machine and a payout on the player's initial represented wager amount.

At 304, the method may include determining, using the math model market selection system, a math model that corresponds to the game identifier. In some implementations, the math model market selection system may send a request for a math model to a game configuration database, where the request includes the game identifier. In some implementations, the request may include a bet denomination. In some implementations, as noted above, the game configuration database may store math models for game themes (e.g., a particular slot machine game, poker, blackjack, baccarat, etc.), as well as different math models that correspond to different bet denominations for the game themes. For example, the game configuration database may store a first math model for a poker game (one game theme) played at a first bet denomination and a second math model for the same poker game played at a second different bet denomination. Likewise, the game configuration database may store a first math model for a blackjack game (a different game theme) at a first bet denomination and a second math model for the blackjack game played at a second different bet denomination. It should be appreciated that the math models for the poker games may differ from the math models for the blackjack game (e.g., different game themes may have different math models). In some implementations, the math model database is associated with one sportsbook server. For example, in some implementations, the math models in the game configuration database may be developed based on competitions and markets offered by one sportsbook server. In alternative implementations, the game configuration database can be associated with multiple sportsbook servers. For example, in some implementations, the math models in the game configuration database may be developed based on competitions and markets offered by multiple sportsbook servers. In some implementations, the game configuration database returns a stored math model that corresponds to a game identifier.

At 306, the method may include determining, using the math model market selection system, a math model definition associated with the math model. In some implementations, the math model market selection system may send a request for a math model definition to a math model database. In some implementations, the request may include a math model identifier. In some implementations, as noted above, the math model database may store math model definitions for the math models. As also noted above, a math model definition may contain, among other information, a math model identifier, an RTP percentage, hit frequencies (volatility), applicable denominations, minimum and maximum bet amounts and a listing of necessary odds for markets to bet on that would statistically conform to the RTP percentage, number of markets to select, weighting of one or more bets in accordance with the designated odds. The math model definitions enable the math model market selection system to determine how to select open markets and determine microbets (e.g., selections) for the selected markets.

In some implementations, at 308, the method may include requesting, from a resolvable market selection system (e.g., resolvable market selection module 220), open markets. As noted above, the open markets are used to determine outcomes for the game played at the electronic game machine. Depending on the type of game played, having outcomes resolved in a timely manner may impact how the game play feels to the player (e.g., if outcomes from the open markets are obtained slowly, the overall game outcome may feel sluggish or broken to the player). To this end, in some implementations, the request for open markets may include a time period in which the open markets should close or resolve. For example, in some implementations, the request may include a time period of 2 seconds, 30 seconds, or some other suitable time period. In some implementations, the necessary time period can be obtained with the math model definition and may vary depending on the game theme that is played. For example, if a game theme at an electronic game machine is a fast play game like a reel-based slot machine game, a player may select to place multiple wagers over a short time period (e.g., rapidly hitting the bet button on the electronic game machine). Thus, in some implementations, the open markets that are used for a fast play game that needs outcomes determined very quickly may use a time period of less than 5 seconds (or some other suitable time period) so the player will not experience delays in obtaining outcomes between wagers. As another example, a game with a slower pace like craps can rely on markets that resolve over a longer time period (e.g., 20 seconds, 30 seconds, or some other suitable time period). In some implementations, including a time period in a request for open markets is not necessary because open markets that are returned can be open markets that are predicted to resolve within a predetermined time period. In some implementations, as shown at 310, the method may include receiving, from the resolvable market selection system, suitable open markets that may be predicted to resolve within a threshold period of time.

In some implementations, as shown at 312, the method may include selecting, using the math model market selection system, a plurality of markets from the suitable open markets that match at least one parameter in the math model definition for the math model. In some implementations, the math model market selection system may analyze the suitable open markets that were supplied by the resolvable market selection system. In some implementations, the math model market selection system may compare one or more attributes of the received suitable open markets against one or more attributes of the math model definition for the game identified at 302. For example, the received open markets may include attribute information such as how soon the open markets will resolve and the odds for available selections for the open markets. In some implementations, the math model market selection system may select one or more of the suitable open markets based on how soon the open markets will resolve and the odds associated with one or more open markets matching with the necessary odds identified in the math model definition obtained in 306. In some implementations, the math model market selection system may use more than one attribute of the open markets to make selections. For example, the math model market selection system may determine that a specific quantity of open markets are identified in the math model definition. The math model market selection system may also analyze the minimum and maximum bet amounts of open markets to determine whether winning bets of the selected open markets would result in the desired RTP percentage for the game identified in the math model definition. It should be appreciated that any suitable quantity of attributes of the suitable open markets can be used to determine whether to select the open markets. In some implementations, one or more markets can be selected from the suitable open markets. The quantity of markets to select may vary depending on the math model definition requirements as well as the available open markets. For example, if a math model definition indicates that a game theme is associated with a large RTP percentage, but the suitable open markets are limited to low payouts, the math model market selection system may need to select a larger quantity of suitable open markets to satisfy the math model definition than if suitable open markets are associated with higher payouts were available or if the RTP percentage was lower for the math model definition.

In some implementations, at 314, the method may include determining, using the math model market selection system, a plurality of selections for the plurality of markets. In some implementations, determining the plurality of selections of the plurality of markets may include determining the type of bet to make. For example, if one of the plurality of markets is predicting the outcome of the next serve in a tennis match, the math model market selection system may determine that the selection is the next serve will result in a double fault. As another example, if one of the plurality of markets is predicting the next play in a football game, the math model market selection system may determine that the selection is the next play will result in a first down or the next play will result in an interception. As a further example, if another one of the plurality of markets is predicting the outcome of the next pitch in a baseball game, the math model market selection system may determine that the selection is the next pitch is a ball or the next pitch will result in a strike. In some implementations, determining the plurality of selections of the plurality of markets also includes determining how to divide the player's initial represented wager amount received at block 302 among the plurality of markets. For example, if a player's initial represented wager amount was $1, the math model market selection system may determine that two markets were selected and that the initial represented wager amount would be split evenly for the two selected markets. Continuing the football and baseball examples above, the math model market selection system may divide the player initial represented wager and assign a $0.50 bet for the football market selection that the next play will result in a first down and assign a $0.50 bet for the baseball market selection that the next pitch is a ball. Other suitable bet value divisions and weightings of the bets can be made depending on the odds and the RTP percentage defined in the math model definition.

In some implementations, as shown at 316, the method may include sending, to a bet placement system (e.g., bet placement module 240), the plurality of selections for the plurality of markets. In some implementations, at 318, the method may also include transmitting, to at least one sportsbook server, the plurality of selections for the plurality of markets. As noted above, the plurality of selections may include, but is not limited to, information such as a bet type and a bet amount. In some implementations, multiple different sportsbook servers can be used to increase the available open markets. However, in some implementations, to reduce complexity, open markets used for determining selections can be limited to open markets from one sportsbook server to reduce the amount of sportsbooks servers to communicate with for receiving open markets, placing selections, and receiving outcomes.

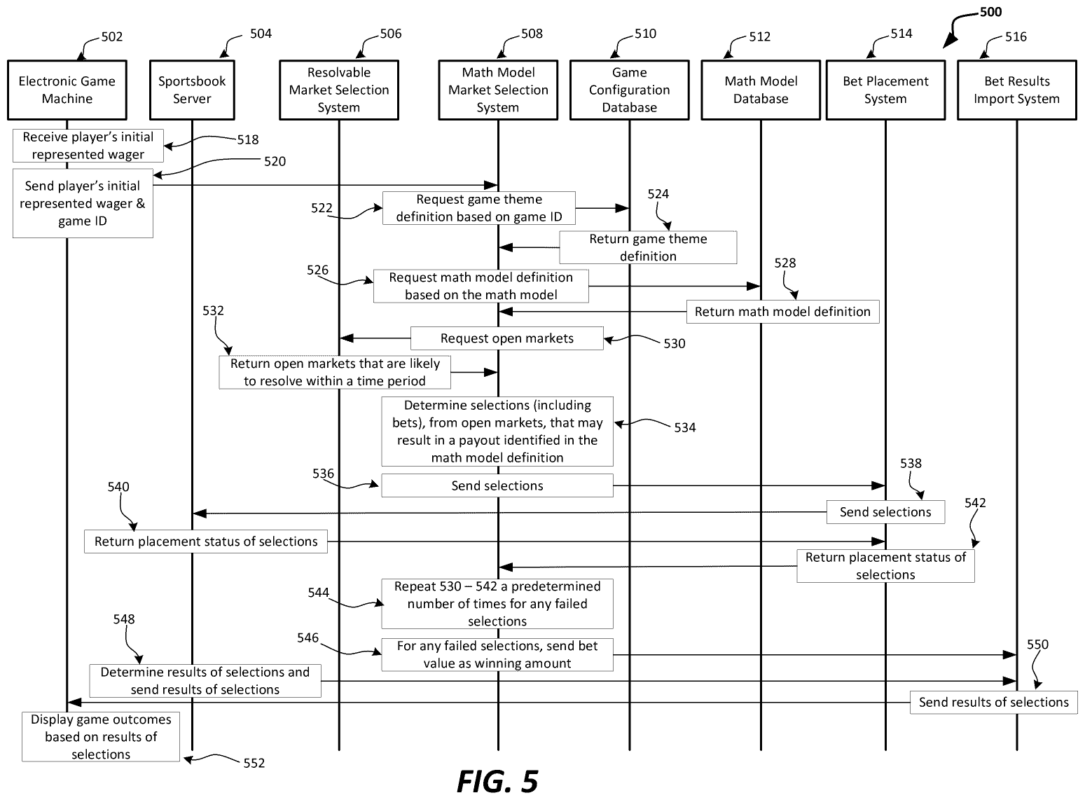

In some implementations, at 320, the method may include receiving, at the bet placement system, confirmation of a placement status of at least one of the plurality of selections from the at least one sportsbook server. In some implementations, it is beneficial to obtain the status of the selections so that a determination can be made whether to attempt to repeat one or more of block 308-block 318 if one or more bets could not be placed with a sportsbook server. In some implementations, block 308-block 318 can be repeated one more times in an attempt to place bets that conform to the math model definition. In some implementations, block 308-block 318 can be repeated a predetermined number of times or repeated as many times as possible during a predetermined time period. In some implementations, as will be discussed in connection with FIG. 5, if one or more selections are not accepted by a sportsbook server (e.g., failure to place a selection/bet), the bet values associated with the failed selections can be incorporated into the determined outcome.

In some implementations, as shown at 322, the method may include receiving, at a bet results system (e.g., bet result import module 250), results of the plurality of selections from the at least one sportsbook server. For example, the at least one sportsbook server may send to the bet results system information indicating whether or not the selections result in wins and any amounts won. In some implementations, as shown at 324, the method may include sending, to the electronic game machine, an outcome based on the results of the plurality of selections. For example, in some implementations, the amounts won for the plurality of selections can be aggregated and provided to the electronic game machine. In some implementations, one or more individual outcomes associated with the plurality of selections can be sent to the electronic game machine.

In some implementations, as shown at 326, the method may include displaying, at the electronic game machine, results of a game associated with the game identifier. The results of the game may be based on the outcome or outcomes received from the at least one sportsbook server. A further explanation of determining the outcome at the electronic game machine and displaying such outcome is discussed in connection with FIG. 5 and FIG. 6A-FIG. 6D.

While some of the functions performed by systems such as the math model market selection system, the resolvable market selection system, the bet placement system, and the bet results system are described as individual systems, in some implementations, they can subsystems (or modules) of a single system, such as described in connection with microbet server 100 and microbet server 200. In some implementations, one or more of the functions performed by the math model market selection system, the resolvable market selection system, the bet placement system, and the bet results system can be performed by one or more distinct systems, such as separate servers that operate together to perform the described functions. For example, the math model market selection system may benefit from having dedicated resources of a standalone server because it performs a large portion of the communications between systems and processes a larger portion of tasks when a player submits a wager. The resolvable market selection system may also benefit from having dedicated resources of a standalone server because it performs constant computations to maintain update to information on available competitions, open markets, and when the open markets will resolve or close. Thus, it should also be appreciated that in some implementations, one or more of the functions described in FIG. 3A and FIG. 3B can be performed by one server or multiple servers.

In some implementations, open markets may be associated with at least one competition. In some implementations, the method may include determining a plurality of values of bets to place for the plurality of selections. In some implementations, a sum of the plurality of values of the bets to place for the plurality of selections may be the value of the initial represented wager (e.g., the initial stake or initial amount that a player put at risk). In some implementations, at least two of the plurality of values of bets to place for the plurality of selections may be different.

In some implementations, at least two of the plurality of values of bets to place for the plurality of selections may be equal. In some implementations, an aggregate value of winning of the bets for the plurality of selections may result in a payout that matches another parameter in the math model definition for the math model. In some implementations, an aggregate value of winning of the bets for the plurality of selections may result in a payout that enables the electronic game machine to maintain an RTP percentage defined in the math model definition associated with game played on the electronic game machine. In some implementations, open markets may be associated with a plurality of different competitions. In some implementations, the method may include determining that a portion of the outcome may be a bet value associated with the rejected at least one of the plurality of selections.

In some implementations, as noted in the discussion of block 320, the method of operating a gaming server may repeat some of the processes in an attempt to place selections with one or more sportsbook servers (e.g., place microbets with sportsbook servers). In some such implementations, the method may include receiving, at the bet placement system, a rejection of at least one of the plurality of selections from the at least one sportsbook server. In some implementations, the method may include requesting, from a resolvable market selection system, additional open markets. In some implementations, the method may include receiving, from the resolvable market selection system, suitable additional open markets that may be predicted to resolve within the threshold period of time. In some implementations, the method may include selecting, using the math model market selection system, at least one additional market from the suitable additional open markets that match the at least one parameter in the math model definition for the math model.

In some implementations, the method may include determining, using the math model market selection system, an additional selection for the at least one additional market to replace the rejected at least one of the plurality of selections. In some implementations, the method may include sending, to a bet placement system, the additional selection for the at least one additional market. In some implementations, the method may include transmitting, to the at least one sportsbook server, the additional selection for the at least one additional market. In some implementations, the method may include receiving, at the bet placement system, confirmation of placement of the additional selection for the at least one additional market from the at least one sportsbook server. In some implementations, the method may include receiving, at a bet results system, results of the additional selection for the at least one additional market from the at least one sportsbook server. In some implementations, the method may include adding the result of the additional selection for the at least one additional market to the outcome.

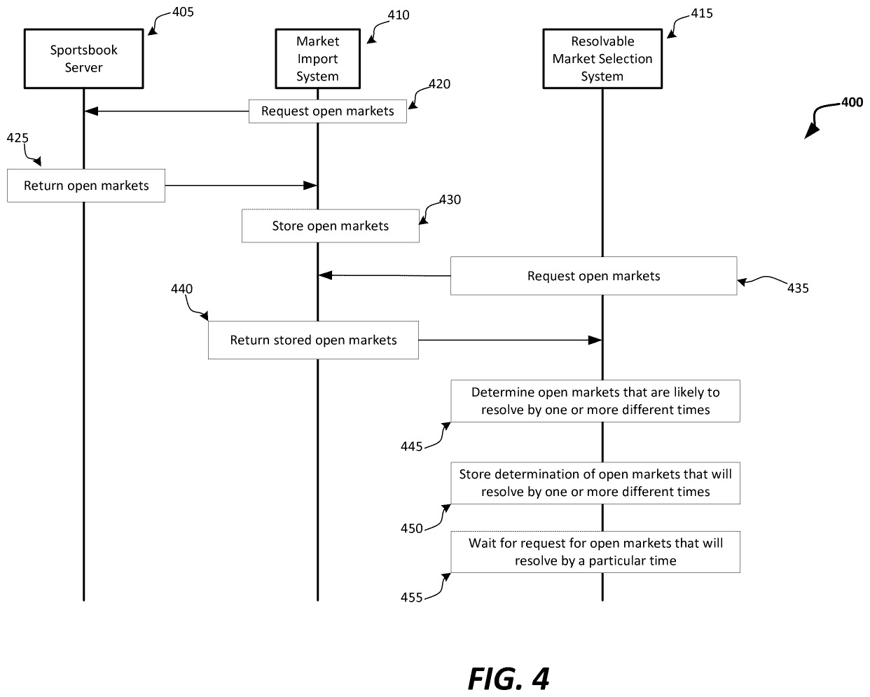

FIG. 4 illustrates communications and processes between different devices and/or systems of a subsystem 400 of a microbet system according to some implementations of the present disclosure. FIG. 4 relates to a subsystem that obtains open markets associated with available competitions from one or more sportsbook servers, organizes the open markets, and provides the open markets to other subsystems of the microbet system. In some implementations, the devices and modules discussed in FIG. 4 correspond to the devices, modules, and systems discussed in other sections of the present disclosure. For example, the resolvable market selection system corresponds to the resolvable market selection module 220 and the resolvable market selection system 506. It should be appreciated that the order of the process illustrated in FIG. 4 is merely one possible implementation. In some implementations, the process illustrated in FIG. 4 may include more blocks or fewer blocks (e.g., more processes or fewer processes). In some implementations, the order of the blocks in FIG. 4 can be arranged in a different order than illustrated and described herein. In some implementations, the process illustrated in FIG. 4 may use more systems or fewer systems than illustrated to accomplish the same functions.

In some implementations, to obtain the latest available competitions and open markets, as shown at 420, market import system 410 may send a request for open markets to sportsbook server 405. In some implementations, market import system 410 may periodically make the request at 420 to sportsbook server 405 to keep its records of available competitions and open markets up-to-date. In some implementations, market import system 410 may communicate with one or more sportsbook servers to obtain a larger variety of open markets. In such situations, block 420 may include sending requests at 420 to plurality of sportsbook servers.

In some implementations, as shown at 425, sportsbook server 405 may transmit open markets to market import system 410. In some implementations, the open markets (e.g., available bets) sent to market import system 410 may include associated information such as bet type (e.g., for a competition that is a baseball game, a bet type may include predicting the outcome of the next pitch), minimum and maximum bet values, odds, and/or other suitable information. In some implementations, the available bets may also include other information such as how long before the open markets resolve or close (e.g., how soon the outcome of the next pitch will be determined). In some implementations, as shown at 430, market import system 410 may store open markets and associated information. In some implementations, market import system 410 may perform further processing on the stored open markets, such as removing markets that are no longer open (e.g., markets that have closed or resolved).

In some implementations, at 435, resolvable market selection system 415 may request stored open markets from market import system 410. In some implementations, this request at 435 can be made at any time. In some implementations, the request at 435 can be made periodically to keep the open market data as current as reasonably necessary. In some implementations, resolvable market selection system 415 may make the request at 435 when it receives a request from a math model market selection system for suitable open markets, such as will be discussed at 530 in FIG. 5. In some implementations, as show at 440, market import system 410 may return stored open markets to the resolvable market selection system 415. In some implementations, resolvable market selection system 415 may store the received open markets.

In some implementations, resolvable market selection system 415 may process the open markets received from market import system 410 to make the data more usable for other systems in the microbet system. For example, as shown at 445, resolvable market selection system 415 may determine open markets that are likely to resolve by one or more different times. This enables the resolvable market selection system 415 to have usable data ready to send to a system such as the math model market selection system and reduce potential delays, rather than waiting to perform the processing at 445 upon a request from another system. In some implementations, resolvable market selection system 415 may perform the process at 445 when resolvable market selection system 415 receives new open market data from market import system 410. In some implementations, as shown at 450, resolvable market selection system 415 may organize and store the determination of open markets that will resolve by one or more different times (e.g., where the process of organizing may employ any one of a number of different suitable data management techniques). In some implementations, as shown at 455, resolvable market selection system 415 may wait for a request for open markets that will resolve by a particular time. In some implementations, resolvable market selection system 415 may periodically remove markets that have closed or resolved so that these markets are not sent to other systems, such as a math model market selection system. Removing markets also reduces the amount of data to process. It should be appreciated that the market import system 410 and the resolvable market selection system 415 may store the open markets data in a database or other suitable data storage system. It should be appreciated that the subsystem 400 can be one part of the process of providing a microbet system, and may work in tandem with the subsystem 500 discussed in FIG. 5 as well as the systems described herein.

FIG. 5 illustrates communications and processes between different devices and/or systems of a subsystem 500 of a microbet system according to some implementations of the present disclosure. FIG. 5 relates to a subsystem that combines the interface of a first game with sports wagering. As was previously discussed in FIG. 1, FIG. 2, FIG. 3A, and FIG. 3B, in some implementations, the player's initial represented wager on a first game at the electronic game machine can be converted into one or more sports wagers placed on one or more different markets associated with one or more different competitions. In some implementations, the outcome of the first game on the electronic game machine is based on the outcome of the one or more sports wagers (e.g., microbets). In some implementations, the devices and modules discussed in FIG. 5 correspond to the devices, modules, and systems discussed in other sections of the present disclosure. It should be appreciated that the order of the process illustrated in FIG. 5 is merely one possible implementation. In some implementations, the process illustrated in FIG. 5 may include more blocks or fewer blocks (e.g., more processes or fewer processes). In some implementations, the order of the blocks in FIG. 5 can be arranged in a different order than illustrated and described herein. In some implementations, the process illustrated in FIG. 5 may use more systems or fewer systems than illustrated to accomplish the same functions. Also, FIG. 6A-FIG. 6D will be described in connection with FIG. 5 to further illustrate the processes discussed in FIG. 5.

In some implementations, as illustrated in FIG. 5, the subsystem may include several different systems and databases, such as electronic game machine 502, a sportsbook server 504, a resolvable market selection system 506, a math model market selection system 508, a game configuration database 510, a math model database 512, a bet placement system 514, and a bet results import system 516 that may communicate to deliver a microbet based sports wagering game.

In some implementations, a play of a microbet based sports wagering game may begin with an electronic game machine 502 receiving at least one player initial represented wager, as shown at 518. As previously discussed, the electronic game machine may display a first game to a player, such as a reel-based slot machine game. To initiate a play of the first game in some implementations, the player may select an initial represented wager and hit a bet or spin button. In some implementations, the initial represented wager will appear like a typical bet that a player would place on a slot machine, but may not become a bet/wager until later bets (e.g., as shown at 538) are placed on selected markets at a sportsbook server. To illustrate the first game, FIG. 6A shows a game screen 600 of an example reel-based slot machine game. The game screen 600 may display a paytable 610, slot machine reels 620, a spin button 630, a balance window 640, an initial represented wager amount window 650, and a win amount window 660. It should be appreciated that illustrated items are merely examples of what a game screen can display, and other suitable game screens may display fewer items, more items, and/or different items. For example, in many video slot machine games, the paytable 610 is not visible unless the player makes an on screen selection to display the paytable. In the example of FIG. 6A, the player may make an initial represented wager selection of $1.00 as shown in the initial represented wager amount window 650 and select the spin button 630 to stake the initial represented wager and initiate the slot machine reels 620 to spin. Returning to FIG. 5, in some implementations, the electronic game machine 502 may send the at least one player's initial represented wager and a game identifier to the math model market selection system 508 as shown at 520. In the example of FIG. 6A, the electronic game machine 502 may send a game identifier that identifies the appropriate reel-based slot machine game (e.g., as opposed to a video poker game or a video blackjack game). In some implementations, the electronic game machine 502 may also send a bet denomination that the player has selected for the game.

Returning to FIG. 5, in some implementations, as shown at 522, the math model market selection system 508 may request at least one game theme definition based on the received game identifier. In some implementations, as shown at 524, the game configuration database 510 may return an appropriate game theme definition to the math model market selection system 508 based on the received game identifier. As noted previously, the game theme definition may include information such as the appropriate math model based on the game theme and the bet denomination that the player has selected to play.

In some implementations, as shown at 526, the math model market selection system 508 may request a math model definition based on the math model identified from the game configuration database 510. In some implementations, as shown at 528, the math model database 512 may return the math model definition to the math model market selection system 508. As previously noted, in some implementations, the math model definition may include, but is not limited to, attributes such as an RTP percentage for the game theme, hit frequencies for the game theme, minimum and maximum bet amounts, a listing of different odds to bet on with one or more sportsbook servers so that microbets placed with the sportsbook servers to conform to the desired RTP percentage for the game theme, and ideal bet close/resolution times. One or more of the elements of math model definition may be used to determine appropriate markets to select and the type of bets to place with the selected markets.

In some implementations, as shown at 530, the math model market selection system 508 may request open markets from the resolvable market selection system 506. In some implementations, as discussed in connection with FIG. 4, resolvable market selection system 506 may have up-to-date lists of a plurality of open markets preselected that will resolve within the predetermined time period. As also discussed above, in some implementations, math model market selection system 508 may request at 530, open markets with particular predetermined parameters for when the open markets will close or resolve. In some implementations, as shown at 532, resolvable market selection system 506 may return open markets that are likely to resolve (e.g., close or end with a determined outcome) within a predetermined time period. In some implementations, the request from math model market selection system 508 does not include time based selection parameters and resolvable market selection system 506 may return a plurality of open markets and allow math model market selection system 508 to filter and select the provided open markets based on suitable parameters from the math model definition.

While resolvable market selection system 506 has provided open markets that will close or resolve within a suitable predetermined time period, the provided open markets may include more open markets than are needed to determine the outcome of the player's bet obtained at 518. To this end, in some implementations, as shown at 534, the math model market selection system 508 may further analyze the open markets obtained from resolvable market selection system 506 to determine specific selections of the open markets that match one or more parameters of the math model definition obtained at 524. In some implementations, determining which selections to make may include determining particular bet types and bet amount values to make with the selected open markets. The selection of the particular open markets, the type of bets to place, and bet values to use (e.g., the “selections”) are designed to result in a payout that would conform to the RTP percentage from the math model definition obtained at 524. As an illustration of the selected open markets and the selections made for the open markets, FIG. 6B shows a table 635a with five selections for five open markets. A first selected open market was predicting the next play will result in a first down in a football game (e.g., bet number 1 in table 635a); a second selected open market is predicting that player 1 will make the next point in a tennis match (e.g., bet number 2 in table 635a); a third selected open market is predicting that the next pitch in a baseball game is a ball (e.g., bet number 3 in table 635a); a fourth selected open market is predicting that team 1 will make the next point in a basketball game (e.g., bet number 4 in table 635a), and a fifth selected open market is predicting that a particular player will make the next touchdown in a football game (e.g., bet number 5 in table 635a). In some implementations, the math model market selection system 508 may have determined that odds associated with these bets listed in table 635a when combined with the particular microbets split (e.g., the value of these microbets or weighting of these microbets) from the player's initial represented wager at 518, may result in a payout that would conform to the RTP percentage from the math model definition obtained at 524. As previously noted, different math model definitions may result in more microbets being placed or fewer microbets being placed. It may depend on the game theme, desired game volatility, and associated math model definitions and also with the type of open markets that are available for microbets. It should also be appreciated that while specific bet types, odds, and bet amounts, and amounts won if bets are won are listed in table 635a, the illustrated values are for example purposes only, and other suitable quantity of bets and values might be used.

It should also be appreciated that specific bet types, odds, and bet amounts, and amounts won if bets are won may change each play of a game depending on the selections available. The types of markets selected may change for other reasons too, including to ensure that an RTP percentage remains within predetermined parameters as set out in the math model definition for a game. For example, the math model market selection system 508 may track the RTP percentage at the electronic game machine 502 for a game. In some implementations, if math model market selection system 508 determines that the statistical RTP percentage at the electronic game machine 502 for a particular game has fallen below predetermined thresholds for an RTP percentage set out in the associated math model definition, math model market selection system 508 may adjust the selections of markets it makes. For example, the math model market selection system 508 may look to select more markets with odds that may return a higher payout if won than are dictated in the math model definition for the game. Similarly, the math model market selection system 508 may look to select more markets with odds that may return a lower payout if won than are set forth in the math model definition for a game if the statistical RTP percentage for the game at electronic game machine 502 is higher than statistically appropriate thresholds.

In some implementations, selections/bets are made based on fixed odds wagering. However, in some implementations, the microbets on sport wager markets can be configured to use parimutuel wagering as an alternative to fixed odds wagering. If microbets are placed in a parimutuel system, the odds for microbets may fluctuate after the microbets are placed (e.g., fluctuating until a market is closed for additional bets), which could lead to unintended variations in the RTP percentage of a game. In some implementations using parimutuel wagering, the math model market selection system 508 may adjust its market selections, as noted above, to attempt to conform the RTP percentage of the game to the RTP percentage set forth in the associated math model definition for the game.

FIG. 6B illustrates more examples of selected open markets and the selections made for the open markets. For example, FIG. 6B shows table 635b with 10 selections for 10 open markets from a variety of in-play tennis matches. In some implementations, math model market selection system 508 may make more selections from the competitions than are needed to satisfy a math model definition. The larger quantity of selections in table 635b enables math model market selection system 508 to hedge against one or more selections not being accepted (e.g., assuming that a few of the selections from a determination at block 534 may not be placed with sportsbook server for any reason). For example, if three of the selections in table 635b are not accepted by sportsbook server 504, the seven remaining selections may be accepted and have potential outcomes that still conform to the RTP percentage for the math model definition. The selections in table 635b also illustrate an example of a low volatility set of selections, where the same bet amount was made on selections having the same (or similar) odds, where the possible win amounts are small and similar. In some implementations, the selections in the example table 635b match with a math model definition that defines a low volatility game where the player may expect small and frequent low wins. The example table 635c illustrates another set of selections from tennis matches that might match with a math model definition that defines a low volatility game where the player may expect small and frequent low wins, but adds in additional variety for the selection odds and provides a larger, but less likely, potential payout. The combination of selections in the example table 635c may be used to provide a large, but infrequent payout, that helps keeps a player entertained and helps achieve the RTP percentage defined in the math model definition. The example table 635d illustrates a set of selections from tennis matches (and adds a few parlay bets—one combining a tennis bet with a basketball bet and one combining a tennis bet with a baseball bet) that might match with a math model definition that defines a high volatility game where the player may expect fewer, but higher value payouts (e.g., as compared to the selection combinations in table 635b and table 635c). The example table 635d illustrates a larger initial represented wager (than tables 635a, 635b, and 635c) that is split into 11 different microbets. The example table 635d also shows a variation in the distribution or weighting of the microbets for the different selections.

In some implementations, as shown at 536, the math model market selection system 508 may transmit the selections determined at 534 to bet placement system 514. In some implementations, as shown at 538, bet placement system 514 may send selections (e.g., the bet types and bet amounts) to sportsbook server 504. In some implementations, sportsbook server 504 represents sportsbook competition and market data coming from a single source (e.g., Draftkings™, FanDuel™, etc.). In some implementations, sportsbook server 504 may include multiple servers, but these multiple servers may be associated with the same source of information. In some implementations, as laws and regulations permit, sportsbook server 504 may represent multiple servers from multiple different sportsbook sources (e.g., e.g., Draftkings™, FanDuel™, etc.). If multiple sportsbook servers are used, 538 may represent sending different selections to different sportsbook servers. In some implementations, multiple sportsbook servers may offer the same open markets at the same time. In some such implementations, the math model market selection system 508 may attempt to send the same selections to different sportsbook servers (e.g., at the same time or sequentially). In some implementations, this is useful in a situation when a particular selection is not accepted at one sportsbook server, but could be accepted at another sportsbook server (See e.g., addressing failed selections identified at 544).

In some implementations, as shown at 540, in some implementations, sportsbook server 504 may return placement status of selections to the bet placement system 514. For example, if sportsbook server 504 received the five selections illustrated in FIG. 6A, sportsbook server 504 may place the bets and send a message to bet placement system 514 that the selections bets have been placed. Alternatively, in some implementations, the sportsbook server 504 may send a message to the bet placement system 514 indicating that one or more of the selections could not be processed (e.g., one or more of the selections failed). Selections may fail for any number of reasons, such as, but not limited to the market may have resolved or closed before the selection can be placed, technical issues prevent placement of a selection, a market will not resolve due to unforeseen circumstances such as a player is injured, etc.). In some implementations, where some selection can be placed along with failed selections, 504 may also provide an indication that some of the selections were placed. In some implementations, as shown at 542, bet placement system 514 may return the placement status of the selections to math model market selection system 508.

In some implementations, as shown at 544, the math model market selection system 508 may repeat one or more of blocks 530-542 at least one time for any failed selections. For example, the math model market selection system 508 attempts to complete as many microbets as possible such that aggregate quantity of microbets (and their possible outcomes) will conform to the RTP percentage of the math model definition. In some implementations, the math model market selection system 508 may repeat one or more of blocks 530-542 continuously for any failed selections for a predetermined period of time. In some implementations, the math model market selection system 508 may repeat blocks 530-542 at plurality of times up to a threshold quantity of times. It should be appreciated that in some implementations, when no selections failed, 544 may not occur.

In some implementations, as shown at 546, when selections failed at sportsbook server 504, math model market selection system 508 may send a bet value for one or more of the failed selections to bet results import system 516 and indicate that these bet values are winning amounts for the player's microbet. For example, if bet number 3 in table 635a failed to be placed with sportsbook server 504, math model market selection system 508 may send the bet value of $0.20 cents to bet results import system 516. In some implementations, bet results import system 516 may treat the received bet value (e.g., $0.20 for bet number 3 in table 635a) as a winning amount that can be added to any other wining amounts the player may receive for the other selections that were accepted by sportsbook server 504.

In some implementations, at 548, sportsbook server 504 may determine the results of the placed selections. For example, the player may determine which of the five bets in table 635a is a winning bet and determine payouts for such winning bets. In some implementations, sportsbook server 504 may transmit the results to bet results import system 516 as shown at 548. In some implementations, the sportsbook server 504 may provide an aggregate amount won to bet results import system 516. In some implementations, the sportsbook server 504 may provide individual listings of the selections that won and lost and provide associated winnings to the bet results import system 516. In some implementations, as shown at 550, the bet results import system 516 may combine any bet values received from math model market selection system 508 (e.g., from block 546) and the other results from sportsbook server 504 and send the results of such selections to electronic game machine 502.

In some implementations, as shown at 552, electronic game machine 502 may receive the results of the selections and further process the results. In some implementations, the electronic game machine 502 may determine how to display the outcome or outcomes of the game to the player. FIG. 6C illustrates one example of a winning outcome of microbets for the reel-based slot machine game. In some implementations, bet results import system 516 may have determined that the results of the selections (e.g., wins from the five microbets from table 635a), totaled to $1.00. For example, the player won bet number 4 from table 635a in FIG. 6B. In some implementations, the electronic game machine 502 may analyze the paytable for the game to determine how to display the winning amount to the player using the symbols on the reel. For example, the paytable 610 in FIG. 6C shows that two cherry symbols along a payline results in a $1.00 win. The paytable 610 also shows that two single cherry symbols appearing along different paylines would also result in a $1.00 win (e.g., $0.50 for one cherry on a payline and another $0.50 for another one cherry on a different payline). Other suitable combinations could be possible. As illustrated in FIG. 6C, electronic game machine 502 chose to display that the reels stopped and two cherry symbols along payline 665 for a win of $1.00 to match the win amount provided by bet results import system 516. As also shown in FIG. 6C, the win amount window 660 displays that the player won $1.00. While the decision on how to display the outcome of the game is discussed in terms of electronic game machine 502 making the determination, other suitable systems of subsystem 500 can be used to make the determinations. For example, the processing could be performed by math model market selection system 508, bet results import system 516, or some other suitable system.

FIG. 6D illustrates another example of a winning outcome of microbets for the reel-based slot machine game. In some implementations, bet results import system 516 may have determined that the results of the selections (e.g., wins from the five microbets from table 635a), totaled to $1.70. For example, the player won bet number 1, bet number 3, and bet number 4 from table 635a in FIG. 6B. In some implementations, the electronic game machine 502 may analyze the paytable for the game to determine how to display the winning amount to the player using the symbols on the reel. For example, the paytable 610 shows that one cherry symbol along a payline results in a $0.50 win; two cherry symbols along a payline results in a $1.00 win; and three strawberry symbols along a payline results in a $0.20 win. Other suitable combinations could be used to display the winning amount. As illustrated in FIG. 6D, electronic game machine 502 chose to display that the reels stopped and three strawberry symbols appeared along payline 665a, two cherry symbols appeared along payline 665b, and one cherry symbol appeared along payline 665c for an aggregate win of $1.70 to match the win amount provided by bet results import system 516. As also shown in FIG. 6D, the win amount window 660 displays that the player won $1.70.

FIG. 6E illustrates another example of an outcome of microbets for the reel-based slot machine game, where the outcomes of the microbets resulted in losses. In some implementations, bet results import system 516 may have determined that the results of the selections (e.g., the 11 microbets from table 635d), totaled to $0.00. That is, none of the microbets from table 635d resulted in a winning outcome in FIG. 6B. In some implementations, the electronic game machine 502 may analyze the paytable for the game to determine how to display that no winning amounts to the player using symbols on the reel. For example, electronic game machine 502 may use one or more symbol combinations that are not displayed in the paytable 610 as resulting in a win for the stopped reel display. Other suitable combinations of symbols could be used to display the losing outcome for the microbets. As illustrated in FIG. 6E, electronic game machine 502 chose to display that the reels stopped and an eggplant and two strawberry symbols appeared along first row of the reels, a cheese symbol, a cherry symbol, and an eggplant symbol appeared along the second row of the reels, and one candy symbol, one strawberry symbol, and one coin symbol appeared along the third row of reels. Since none of the symbol combinations on slot machine reels 620 appear in the paytable 610, the outcome displayed by the electronic game machine 502 matches the losing microbet outcomes provided by bet results import system 516. As also shown in FIG. 6E, the win amount window 660 displays that the player did not win any money.

It should be appreciated that the improved microbet gaming system disclosed herein provides a new type of game experience for a player that were not previously been available in jurisdictions that allow sports wagering games, but prohibit traditional casino games. In some implementations, the improved microbet gaming system enables players to use familiar game interfaces, such as electronic game machines providing traditional casino games, and convert such games into legally permitted sports wagering games. It should also be appreciated that the foregoing disclosure provides technical solutions to the technical problems outlined above.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations have been described. Various modifications may be made without departing from the spirit and scope of the description. For example, various forms of the flow charts shown above may be used, with steps re-ordered, added, or removed. Accordingly, other implementations are within the scope of the following claims.

What is claimed:

1. A method of operating a gaming server, comprising:
receiving, at a math model market selection system, a game identifier and an initial represented wager amount from an electronic game machine;
determining, using the math model market selection system, a math model that corresponds to the game identifier;
determining, using the math model market selection system, a math model definition associated with the math model;
requesting, from a resolvable market selection system, open markets;
receiving, from the resolvable market selection system, suitable open markets that are predicted to resolve within a threshold period of time;
selecting, using the math model market selection system, a plurality of markets from the suitable open markets that match at least one parameter in the math model definition for the math model;
determining, using the math model market selection system, a plurality of selections for the plurality of markets;
sending, to a bet placement system, the plurality of selections for the plurality of markets;
transmitting, to at least one sportsbook server, the plurality of selections for the plurality of markets;
receiving, at the bet placement system, confirmation of a status of at least one of the plurality of selections from the at least one sportsbook server;
receiving, at a bet results system, results of the plurality of selections from the at least one sportsbook server; and
sending, to the electronic game machine, an outcome based on the results of the plurality of selections.

2. The method of operating the gaming server of claim 1, wherein open markets are associated with at least one competition.

3. The method of operating the gaming server of claim 1, further comprising determining a plurality of values of bets to place for the plurality of selections.

4. The method of operating the gaming server of claim 3, wherein a sum of the plurality of values of the bets to place for the plurality of selections is the value of the initial represented wager.

5. The method of operating the gaming server of claim 3, wherein at least two of the plurality of values of bets to place for the plurality of selections are different.

6. The method of operating the gaming server of claim 3, wherein at least two of the plurality of values of bets to place for the plurality of selections are equal.

7. The method of operating the gaming server of claim 3, wherein an aggregate value of winning of the bets for the plurality of selections results in a payout that matches another parameter in the math model definition for the math model.

8. The method of operating the gaming server of claim 1, wherein open markets are associated with a plurality of different competitions.

9. The method of operating the gaming server of claim 1, further comprising receiving, at the bet placement system, a rejection of at least one of the plurality of selections from the at least one sportsbook server.

10. The method of operating the gaming server of claim 9, further comprising determining that a portion of the outcome is a bet value associated with the rejected at least one of the plurality of selections.

11. The method of operating the gaming server of claim 9, further comprising:
requesting, from a resolvable market selection system, additional open markets;
receiving, from the resolvable market selection system, suitable additional open markets that are predicted to resolve within the threshold period of time;
selecting, using the math model market selection system, at least one additional market from the suitable additional open markets that match the at least one parameter in the math model definition for the math model;
determining, using the math model market selection system, an additional selection for the at least one additional market to replace the rejected at least one of the plurality of selections;
sending, to a bet placement system, the additional selection for the at least one additional market;
transmitting, to the at least one sportsbook server, the additional selection for the at least one additional market;
receiving, at the bet placement system, confirmation of placement of the additional selection for the at least one additional market from the at least one sportsbook server;
receiving, at a bet results system, results of the additional selection for the at least one additional market from the at least one sportsbook server; and
adding the result of the additional selection for the at least one additional market to the outcome.

12. A gaming server, comprising:
at least one processor; and
at least one memory that stores computer executable instructions, wherein, when the computer executable instructions are executed by the at least one processor, the at least one processor is configured to:
receive, from an electronic game machine, a game identifier and an initial represented wager amount;
determine a math model that corresponds to the game identifier;
determine a math model definition associated with the math model;
obtain suitable open markets that are predicted to resolve within a threshold period of time;
select a plurality of markets from the suitable open markets that match at least one parameter in the math model definition for the math model;
determine a plurality of selections for the plurality of markets;
transmit, to at least one sportsbook server, the plurality of selections for the plurality of markets;
receive, from the at least one sportsbook server, confirmation of a status of at least one of the plurality of selections from the at least one sportsbook server;
receive results of the plurality of selections from the at least one sportsbook server; and
send, to the electronic game machine, an outcome based on the results of the plurality of selections.

13. The gaming server of claim 12, wherein the suitable open markets are associated with at least one competition.

14. The gaming server of claim 12, further comprising determining a plurality of values of bets to place for the plurality of selections.

15. The gaming server of claim 14, wherein a sum of the plurality of values of the bets to place for the plurality of selections is the value of the initial represented wager.

16. The gaming server of claim 14, wherein at least two of the plurality of values of bets to place for the plurality of selections are different.

17. The gaming server of claim 14, wherein at least two of the plurality of values of bets to place for the plurality of selections are equal.

18. The gaming server of claim 14, wherein an aggregate value of winning of the bets for the plurality of selections results in a payout that matches another parameter in the math model definition for the math model.

19. The gaming server of claim 12, wherein suitable open markets are associated with a plurality of different competitions.

20. The gaming server of claim 12, wherein the computer executable instructions further cause the at least one processor to: receive a rejection of at least one of the plurality of selections from the at least one sportsbook server.

21. The gaming server of claim 20, wherein the computer executable instructions further cause the at least one processor to: determine that a portion of the outcome is a bet value associated with the rejected at least one of the plurality of selections.

22. The gaming server of claim 20, wherein upon receiving the rejection of the at least one of the plurality of selection, the computer executable instructions further cause the at least one processor to:
obtain suitable additional open markets that are predicted to resolve within the threshold period of time;
select at least one additional market from the suitable additional open markets that match the at least one parameter in the math model definition for the math model;
determine an additional selection for the at least one additional market to replace the rejected at least one of the plurality of selections;
transmit, to the at least one sportsbook server, the additional selection for the at least one additional market;
receive confirmation of placement of the additional selection for the at least one additional market from the at least one sportsbook server;
receive results of the additional selection for the at least one additional market from the at least one sportsbook server; and
add the result of the additional selection for the at least one additional market to the outcome.
